(19) United States
(12) Patent Application Publication
(10) Pub. No.: US 2007/0106647 A1
(43) Pub. Date: May 10, 2007

(54) PROPERTY TAX AND TITLE CHAIN DOCUMENT ORDERING SYSTEM AND METHOD

(76) Inventor: Edward M. Schwalb, Irvine, CA (US)

Correspondence Address: FIRST AMERICAN REAL ESTATE;c/o SNELL & WILMER, LLP, 600 ANTON BOULEVARD, SUITE 1400, COSTA MESA, CA, 92626, US

(21) Appl. No.: 11/555,190

(22) Filed: Oct. 31, 2006

Related U.S. Application Data
(60) Provisional application No. 60/731,898, filed on Oct. 31, 2005.

(51) Int. Cl. G06F 17/30; G06Q 99/00; G06F 15/16; G06F 17/00

(52) U.S. Cl. 707/3; 705/1; 709/203; 715/513

(57) ABSTRACT

The present invention is an integration platform providing access to property tax and title document index (a.k.a. title plant) backend. The present invention is to provide the benefits of so-called thick-client architecture, with their real-time responsiveness and ability to browse through large numbers of huge reports and image collections, with so-called thin-client architectures, with their seamless software update capabilities and reduce centralized maintenance costs. The present invention serves as a title chain report and scanned document image ordering and download gateway. The present invention allows submission of requests in a batch and subsequent off-line browsing and analysis of fulfilled orders, and operates under challenging conditions of intermittent connections performing automatically data download resumption, therefore minimizing the dependency on live connections to situations where new data is required.

### CLAIM OF PRIORITY UNDER 35 U.S.C. §119

The present Application for Patent claims priority to Provisional Application No. 60/731,898, filed on Oct. 31, 2005, and assigned to the assignee hereof and hereby expressly incorporated by reference herein.

### BACKGROUND

1. Field of the Invention

The invention generally relates to online database search applications in the context of supporting the title insurance underwriting process. More particularly, the invention relates to a system and method for the integration of tax property information, title chain indexing and scanned document image retrieval.

2. Related Art

Web-based and software applications are used by many individuals and businesses to facilitate online transactions. For example, many individuals use web applications (e.g., www.amazon.com and www.ebav.com) via the Internet to view and place orders. In addition, many web and software applications have been developed to improve productivity of administrative operations. Some examples of these applications include human resources operations, supply chain operations, and sales force automation.

The title insurance industry, however, has seen slower development and adoption of web-based and software applications. Existing web-based and software applications for the title insurance industry are supported by large mainframe databases that index millions of property tax and title documents and store millions of scanned document images. To fulfill an order, a title insurance company assembles packages of documents related to a specific title policy transaction. The packages contain a large volume of data, for example, a large number of pages or a large amount of disk space. Therefore, one challenge in the title insurance industry is to develop web-based and software applications that can manipulate the packages efficiently and effectively over relatively slow network connections.

FIG. 1 is a block diagram of a prior art thin-client system. The thin-client system includes a 3270 screen scraping web-application that utilizes a Java Applet. The Java Applet relies on a 3270 screen-scraper middle-tier. The web-application is a web-browser that views a static HTML page with an embedded applet. The embedded applet uses standard Java libraries to connect to middle-tier components, over HTTP, using custom protocols provided by a third party vendor of an off-the-shelf product. In the back-end, the middle-tier interfaces has a 3270 emulator, which in turn communicates with a mainframe application using 3270 data streams over LAN connections.

### SUMMARY

The present invention provides a broad architecture that improves performance of the Graphic User Interface (GUI), reduces network traffic, reduces the potential volume of defect opportunities, reduces the time to market for rollout of new features, reduces the time to rollout new counties, and reduces overall maintenance costs. Users can perform complex streaming and retry logic, implement improved error handling protocols and use custom protocol adapters that are used for integration with legacy systems. The present invention provides the capability for customers to manage a large local repository of fulfilled orders, having GBytes of data, avoiding the need for repeated re-transmission of data as would be expected from server side repository solutions. The present invention allows off-line browsing and analysis of fulfilled orders, minimizing the dependency on live connections to situations where new data is required.

The present invention provides the benefits of so called thick-client architecture, with real-time responsiveness, and the ability to browse through large numbers of huge reports and image collections, with so-called thin-client architectures, with their seamless software update capabilities and reduced centralized maintenance costs. The present invention allows rapid, cost-effective, and low maintenance wrapping of legacy code for legacy applications, including MF applications, and generating of large reports and indexing of large image repositories, to rapidly introduce modem web-application based products to market.

The present invention allows for reusing existing large code bases that heavily rely on large XML files, large DTD files or large XSD files. As an example, large XSLT files or crystal reports code bases can be used to generate large reports. Such code bases are typically not well documented, fragile to minute changes in the XML structure, and very difficult to redesign. The present invention allows automated code optimization of large XSLT report generation through the use of XSLT accelerators.

The present invention minimizes the need for pushing client updates, also known as releases, by maximizing the body of functionality and logic delivered by the server. The transmission of JavaScript with the HTML to the client application achieves this goal. The present invention allows a team of low-skilled individuals, skilled in the specific art of XSLT maintenance, to maintain the vast majority of the business logic embodied in the system.

The present invention maximizes the responsiveness of the client application while manipulating tens of thousands of reports and document images in the local repository. The present invention allows the users to seamlessly retrieve data from a plurality of web-sites when the data they provide is more recent than that available in the backend database or missing altogether.

The present invention allows users to specify a number of searches and request that the reports and images be downloaded in the background, in batch mode, while the application's window is minimized or otherwise inactive. The client application can be used as a transaction specific data download gateway, running numerous threads and processes in the background.

### BRIEF DESCRIPTION OF THE DRAWINGS

Claimed subject matter is particularly pointed out and distinctly claimed in the concluding portion of the specification. However, such subject matter may be understood by reference to the following detailed description when read with the accompanying drawings in which:

FIG. 1 is a block diagram of a prior art thin-client system.

FIG. 2 is a block diagram of a client system according to an embodiment of the invention.

FIG. 3 includes several flow diagrams illustrating methods of searching, linking, reviewing and exporting documents and images according to one or more embodiments of the invention.

FIG. 4 is a block diagram of a client system having a client PC, a middle-tier layer and a database search logic layer according to an embodiment of the invention.

FIG. 5 is a graphic user interface (GUI) according to an embodiment of the invention.

FIG. 6 is a GUI illustrating a search results HTML report according to an embodiment of the invention.

FIG. 7 is a GUI illustrating an image viewer layout according to an embodiment of the invention.

FIG. 8 is a GUI illustrating a split screen report and an image viewer layout according to an embodiment of the invention.

FIG. 9 is a block diagram of an XML fan-out transformation into ZIP over HTTP and HTML panel data flows according to an embodiment of the invention.

FIG. 10 is a flow diagram showing events of a transaction type for downloading and caching a county specific website according to an embodiment of the invention.

FIG. 11 is a GUI that allows placing orders using a search list shopping cart concept where all operations are performed without server interactivity (i.e., offline) according to an embodiment of the invention.

FIG. 12 is a flow diagram showing several possible paths that can occur for event propagation and information exchange between the browser and the client modules according to an embodiment of the invention.

FIG. 13 are screen shots of history panels according to an embodiment of the invention.

FIG. 14 are screen shots of history and image panels according to an embodiment of the invention.

FIG. 15 is a screen shot of a document image viewer layout according to an embodiment of the invention.

FIG. 16 is a flow diagram showing the automated optimization of XSLT report generation according to an embodiment of the invention.

FIG. 17 is a flow diagram illustrating a method of integrating streaming and segmentation according to an embodiment of the invention.

FIG. 18 is a portion of a GUI illustrating segmentation GUI control according to an embodiment of the invention.

FIG. 19 illustrates a summary view of the results according to an embodiment of the invention.

FIG. 20 illustrates a partially expanded view in which the user selectively expands individual postings of interest according to an embodiment of the invention.

FIG. 21 illustrates a fully expanded view in which all the fields for all postings are shown according to an embodiment of the invention.

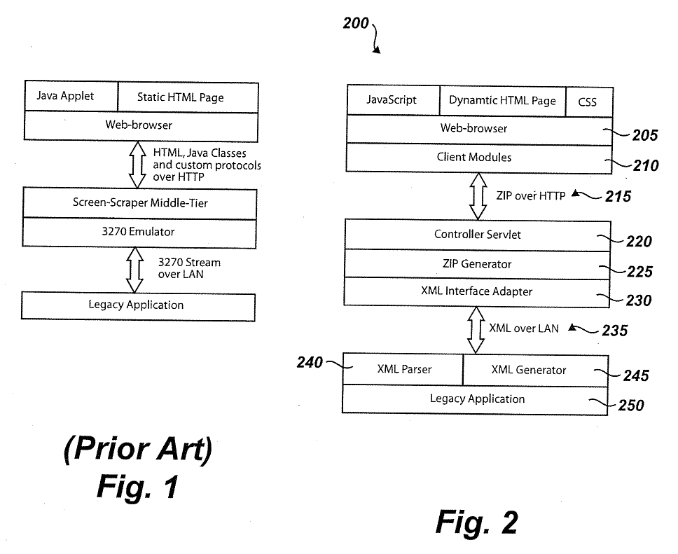

### DETAILED DESCRIPTION

Methods and apparatus that implement the embodiments of the various features of the disclosure will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment. Throughout the drawings, reference numbers are re-used to indicate correspondence between referenced elements. In addition, the first digit of each reference number indicates the figure in which the element first appears.

FIG. 2 is a block diagram of a client system 200 according to an embodiment of the invention. The client system 200 may be a thin-client application that provides all the amenities and functionality typically delivered by a thick-client application. The client system 200 may include a web-browser 205, client modules 210 develop using C#, and a state-of-the-art procedural language, which has similar characteristics to Java. The client system 200 utilizes Dynamic Hypertext Markup Language (DHTML) and Asynchronous JavaScript and XML (AJAX), which utilizes JavaScript to provide interactivity and exchange events with the client modules 210. In the back-end, the middle-tier communicates with the backend mainframe database using Extensible Markup Language (XML) over custom legacy Hypertext Transfer Protocol (HTTP) protocols. To allow for such interfacing, the mainframe application includes an XML parser 240 and an XML generator 245.

The client system 200 uses ZIP over HTTP 215 to fan-out responses. Rather than respond to an HTTP request with a single HTML page, the middle-tier assembles a ZIP package of HTML pages that constitutes the equivalent of an entire web-site. The client modules 210 may extract the individual components of the package, save them locally and point the web-browser to the appropriate HTML pages. The links of all these HTML pages are shallow, namely pointing to the local PC.

The client application runs on a client PC, connected, over the Internet, to a middle-tier component, which in turn is connected to a backend database component over a LAN. The client application connects to a scanned document image middle tier or database over the Internet. The client application prints to a printer connected over the LAN. Some embodiments include a client application running on a single terminal servers or a terminal server farm. All possible connection options are available, including the Internet, WAN and LAN, between the client application, the printer, the middle-tier and the backend database. The client application may connect to the scanned document image middle-tier or database, over the Internet, WAN or LAN. The printer may connect to the client PC over the Internet, WAN or LAN. Some embodiments include the client application residing on a mobile computing device whose (wireless) connection to the network is continuous or intermittent. Some embodiments include setup of multiple build, development, staging and production environments, and corresponding client application versions, which facilitate an orderly software development and quality assurance process. The system relates to front-end aspects (e.g., GUI) and back-end aspects. Some embodiments may utilize software, hardware or a combination of software and hardware technologies such as Windows, Linux, web-browser components, C#.NET, HTML, JavaScript, XSLT, Java J2EE, open source middle-tier components, and XSLT accelerators.

XSLT accelerators reduce transformation latency and increase throughput by two orders of magnitude. The use of XSLT accelerators needs converting code designed to run under a specific software transformation engine, such as Xalan, to run on a specialized XSLT acceleration box, such as DataPower. To avoid double maintenance of source code, the source XSLT code is passed through an XSLT transformation to produce slightly modified XSLT code which runs on the accelerator box. This transformation can be applied during the build process, deployment process or automatically as report generation requests are being made.

The system and method may provide a title chain report and a scanned document image ordering and download gateway. The system and method may provide the ability to integrate complex segmentation with streaming and retry logic, use custom protocol adapters that are required for integration with legacy systems, and manage a large local repository of fulfilled orders having gigabytes of data. The system and method may allow for the submission of requests in a batch and subsequent off-line browsing and analysis of fulfilled orders, and may operate under challenging conditions of intermittent connections performing automatic data download resumption, therefore minimizing the dependency on live connections to situations where new data is required.

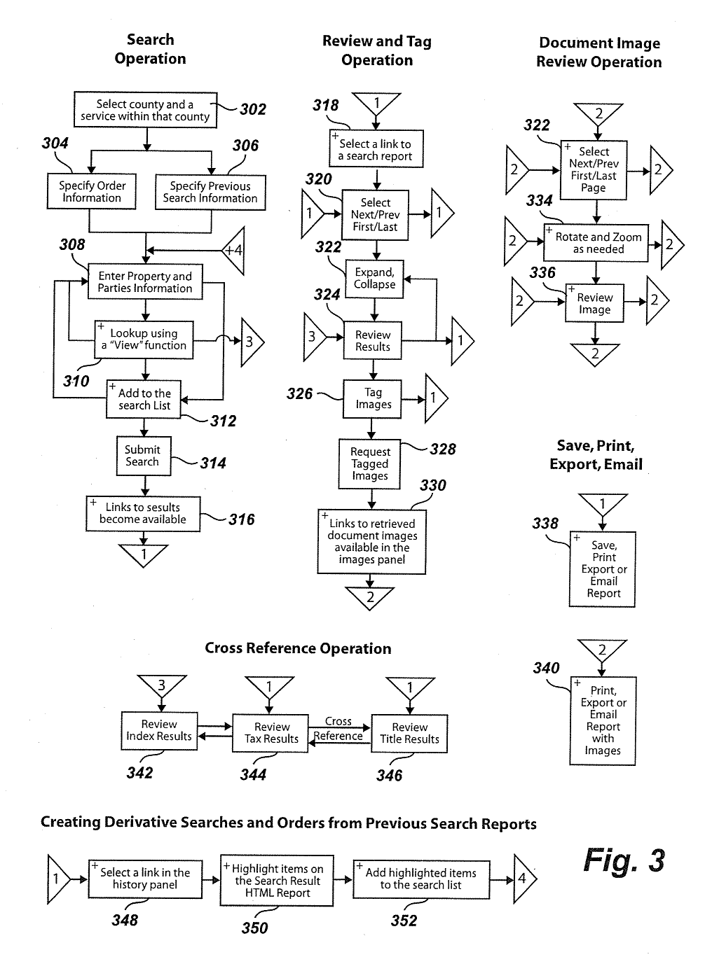

FIG. 3 includes several flow diagrams illustrating methods of searching, linking, reviewing and exporting documents and images according to one or more embodiments of the invention. Users log onto the system using a typical method of entering login information. Once the login is completed, the user selects a county and a service within the county (302). The user may enter or specify order information (304) or enter or specify search information (306). The user is able to enter numerous parameters (e.g., property and party information) using a search list (308) or lookup numerous parameters using a view function (310). For example, the search list may parallel a shopping cart feature used by online retailers. Items can be edited, added to, or removed from, the search list (312). Once the search list is complete, the search is submitted and the results are downloaded (314). Once the results are downloaded, the client application generates links, pointing to the downloaded results on the local PC (316). The user may select a link to a search report (318) or may select a next, previous, first or last search report (320). The system allows reviewing the results offline, viewing the results in summary mode, and individually expanding and collapsing items of interest (322, 324). Further, the system enables annotating the results using a strikeout operation.

Users may tag documents for which the scanned document image is requested (326, 328). The tagging may be performed by selecting HTML check-boxes. Once tagged and requested, links to the downloaded document image files are automatically populated in the images panel (330). Images can be selected, rotated, zoomed, viewed and annotated interactively (332, 334). Further, images can be reviewed side-by-side with the title change report from which they were tagged (336).

The index results can be cross-referenced with the tax results and, conversely, the tax results can be cross-referenced with the index results (342, 344). The tax results can be cross-referenced with the title results and, conversely, the title results can be cross-referenced with the tax results (344, 346). Users can select a link in the history panel (348) and select items on the search result HTML report (350) to be added to the search list (352). This operation allows users to interactively create searches and orders which are derivative of previously performed searches in the history panel.

The search result reports can be saved, printed, exported or emailed (338, 340). Users can annotate reports using strikeout operations, and annotate images using rectangles, arrows, highlighting and other annotations, and print the annotated report and images. Further, users can export the annotated reports and images using a common file format, as well as to automatically create email messages with those files attached.

The client application can be installed on standard PCs, execute requests to a middle-tier server and process ZIP files containing cashed HTML file responses. The use of a ZIP file to compress dozens of HTML pages reduces network traffic by an order of magnitude since the compressed package is slightly larger than a single HTML page. Some embodiments include a client application deployer and a server interaction module. In addition to network traffic reduction, the use of ZIP compression reduces server memory requirements by an order of magnitude. Other embodiments include legacy-system upgrades, whereby the present architecture is used to provide modem web-enabled software capabilities while preserving investment in legacy systems.

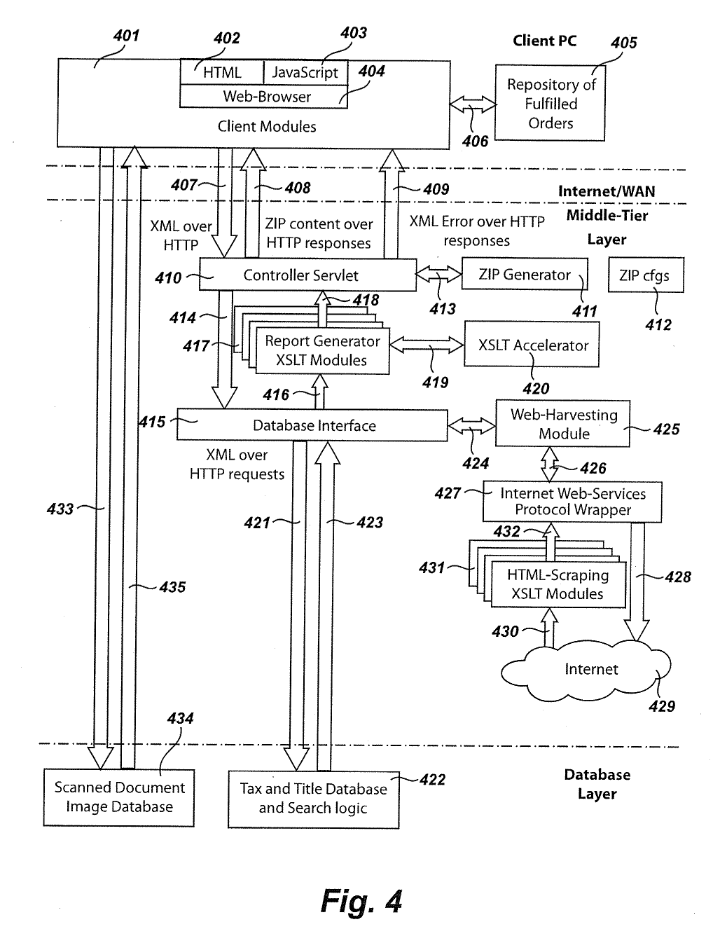

FIG. 4 is a block diagram a client system having a client PC, a middle-tier layer and a database search logic layer according to an embodiment of the invention. The client PC includes software such as a Windows application. The software may also include client modules 401, a web-browser module 404, which is capable of generating HTML pages 402, and executed JavaScript code 403. The client module 401 may download property tax, title chain reports and scanned document images, which are stored in repository or memory 405. The memory 405 may be local to the client PC, for example, the memory 405 may be part of the client modules 401 or may be accessible via a local area network 406.

Upon login and selection of a specific county or submission of a search request, the client modules 401 sends an XML request 407 over an HTTP, across the Internet or Wide Area Network (WAN), to a controller servlet 410, which resides in the middle-tier layer. The controller servlet 410 transmits the HTTP request 407 to a database 422, retrieve the XML results and pass the results to a ZIP generator 411. The ZIP generator 411 inspects the ZIP configuration and manifests files 412 and generates a ZIP data stream 413 and passes the ZIP data stream 413 to the controller servlet 410. If no error occurred, the ZIP data stream 413 is converted into a ZIP file and passes the ZIP file through an HTTP response 408 to the client modules 401. The client modules 401 unzip the payload of the response and store the files in the memory 405. If an error occurred, rather than returning a ZIP file, the controller servlet 410 returns an XML file through the HTTP response 408 indicating to the client modules 401 which error occurred and what action is to be taken.

The controller servlet 410 processes the XML request 407 and transmits a modified XML request 414 to a database interface 415 residing in the middle-tier layer. The database interface 415 transmits the modified XML request 421, over the Local Area Network (LAN), the WAN or the Internet, to the database 422, which transmits an XML response 423 to the database interface 415. The XML response 423 is transmitted to an XSLT module 417 for conversion into a plurality of HTML files, which are transmitted to the ZIP generator 411 through the controller servlet 410.

When a search request requires a long processing time, the database 422 returns to the client PC, through the database interface 415 and the controller servlet 410, with an XML response (i.e., error condition) indicating that the client PC is going to try again within a few seconds. The client PC may wait for a time period and poll the database 422 through the controller servlet 410 and the database interface 415. If at the time of polling, the result is not yet available, the client PC is notified to try again. The polling time increases with each successive failure, until a timeout is reached. If at the time of polling, the result is available, the database 422 places the result in an XML response 423, transmits the XML response 423 to the database interface 415, which transforms the XML response 423 into a number of HTML files, representing a cashed response mini-site, using a number of XSLT modules 417, packages the HTML files as a ZIP file and returns the resulting ZIP file to the client PC.

When the data is not available in the database 422, as indicated by the XML response 423, the database interface 415 may choose to forward the modified XML request 421 to a web-harvesting module 425. The web-harvesting module 425 may forward the modified XML request 421 to an Internet web-services protocol wrapper 427, which may transform the modified XML request 421 to the requestsed format supported by the target web-site and perform the search request typically using HTTP get or post 428. The web-server powering the web-site returns an HTML response 430, which is converted into XML using a number of XSLT modules 431 producing an XML 432 which is identical in format to the XML that is produced by the database 422.

Document image requests, performed by the GUI, are forwarded XML requests 433 from the client modules 401 directly to a document image provider server 434, which provides an XML response containing a status of the document image retrieval or sufficient information to assemble a URL pointing to the document image file. Subsequently, the document image file is retrieved using a standard HTTP-GET request.

One or more of the following transaction types may be implemented using the present invention.

Registration Transaction: Registration transactions submit hardware identification information and establish a workstation identifier.

Logon Transaction: Logon transactions submit a station identifier and establish a session. Upon login, the client modules 401 automatically perform a county selection transaction pointing to a default county.

County Transaction: County transactions obtain a county specific ZIP file having numerous HTML files where the links are local and function when the files are saved to the local repository.

Search Transaction: Search transactions submit a search and obtain a search ID or token to be used for subsequent polling and data retrieval.

Results Transaction: Results transactions poll the database search logic to determine whether the search was completed. If the search was not completed, the response includes an XML indicating the status of the request. If the search was complete, the response includes an XML containing the search results.

Document Image Transaction: Document image transactions submit a request for extraction of a document image from a database of scanned documents. Until the extraction is complete, the client PC polls the server. Once complete, the client PC receives a URL from which the document image file can be retrieved. Subsequently, the image file is retrieved via HTTP get and saved in a repository local to the client PC.

Lookup and Administrative Transaction: Lookup and administrative transactions mimic the traditional web-application modus of operandi. A request is sent to the middle-tier layer, which is forwarded to the database to display or update the data associated with a small number of records that represent an order or settings for a specific login.

The client system shown in FIG. 4 supports all these transaction types. The client modules 401 contain components found in a Windows application including a printing component and protocol adapters for these transaction types. In addition, a special adapter may be needed to facilitate the communications between the web-browser and the client modules.

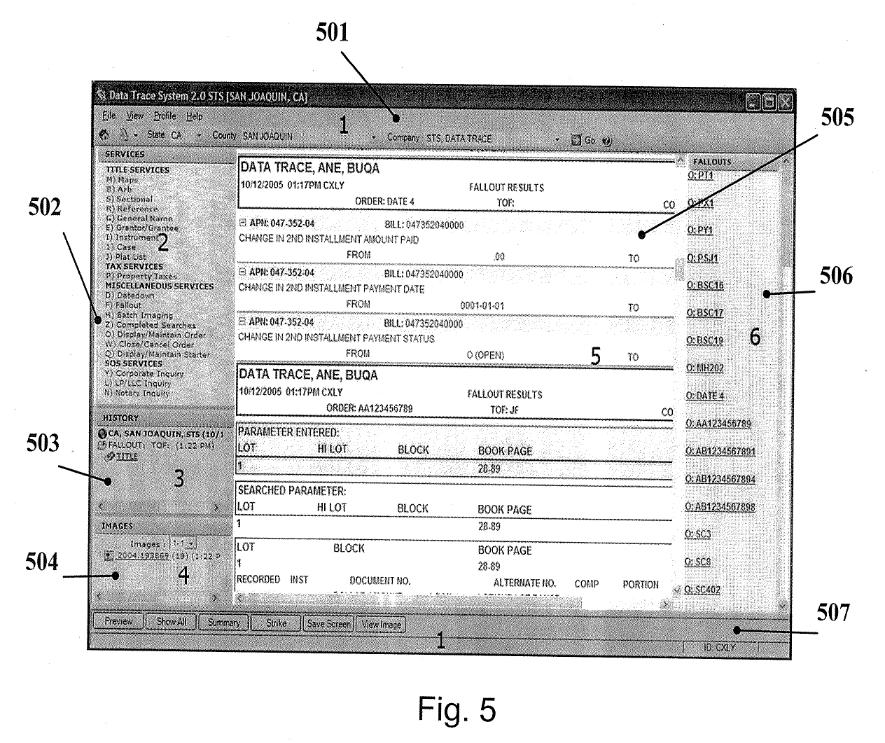

FIG. 5 is a graphic user interface (GUI) layout according to an embodiment of the invention. The GUI layout includes a global features toolbar 501, a services panel 502, a history panel 503, an images panel 504, an applications panel 505, a results index panel 506, and an applications toolbar panel 507. The global features toolbar 501 includes menu items, print controls and a county selector. The services panel 502 lists all services available for the county selected within the logon used and residing in the local order fulfillment repository. The history panel 503 includes links to property tax and title chain orders fulfilled within the current logon session and residing in the local order fulfillment repository. The images panel 504 includes links to document images and orders fulfilled within the current logon session and residing in the memory 405. The applications panel 505 includes user interface controls for the review of the property tax report, title chain report or document images retrieved. The results index panel 506 includes links that serve as table of content shortcuts to the content of the reports. The applications toolbar panel 507 includes buttons and controls for performing operations on the content of the applications panel 505.

The services panel 502 and the history panel 503 may contain links to tens of thousands of HTML reports and document images that can be viewed in the applications panel 505. The HTML reports and document images can be stored in the memory 405. The applications panel 505 may contain HTML reports having hundreds of pages that allow for the tagging and retrieval of hundreds of document images.

The services panel 502, the history panel 503, the images panel 504, the applications panel 505 and the results index panel 506 may be implemented using HTML files delivered within the ZIP files retrieved for the logon transaction, where the interactivity is provided by JavaScript (a.k.a. DHTML user interface). The content of the application toolbar panel 507 may be controlled by an XML file transmitted to the client PC within the transaction ZIP response. The global features toolbar 501 and the applications toolbar panel 507 may be implemented as part of the client modules 401.

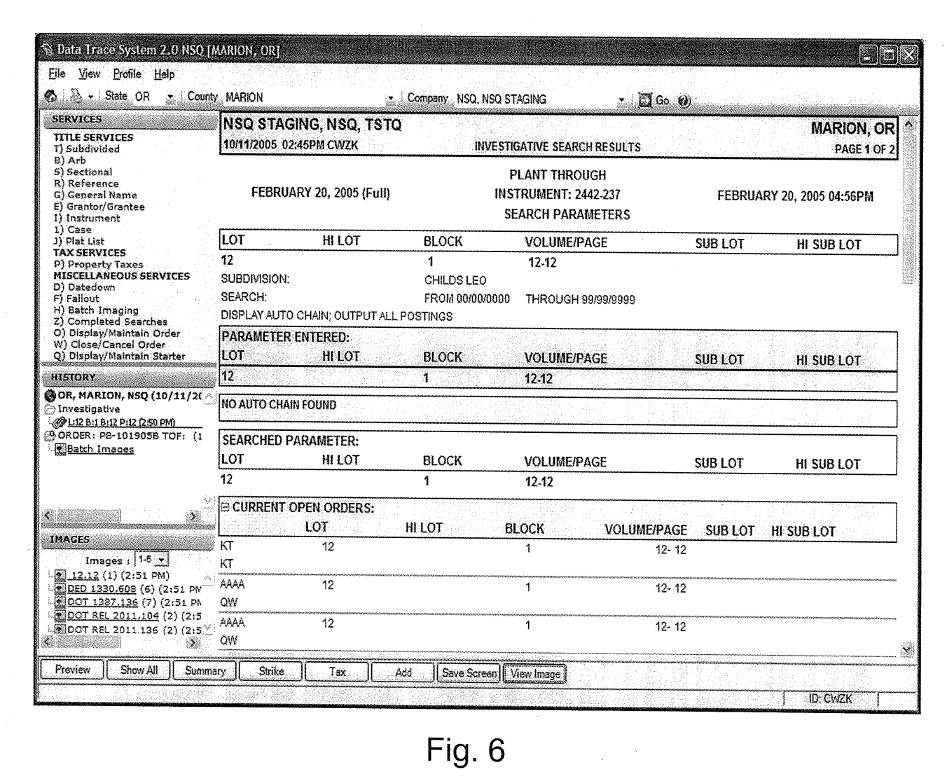

FIG. 6 is a GUI illustrating a search results HTML report according to an embodiment of the invention.

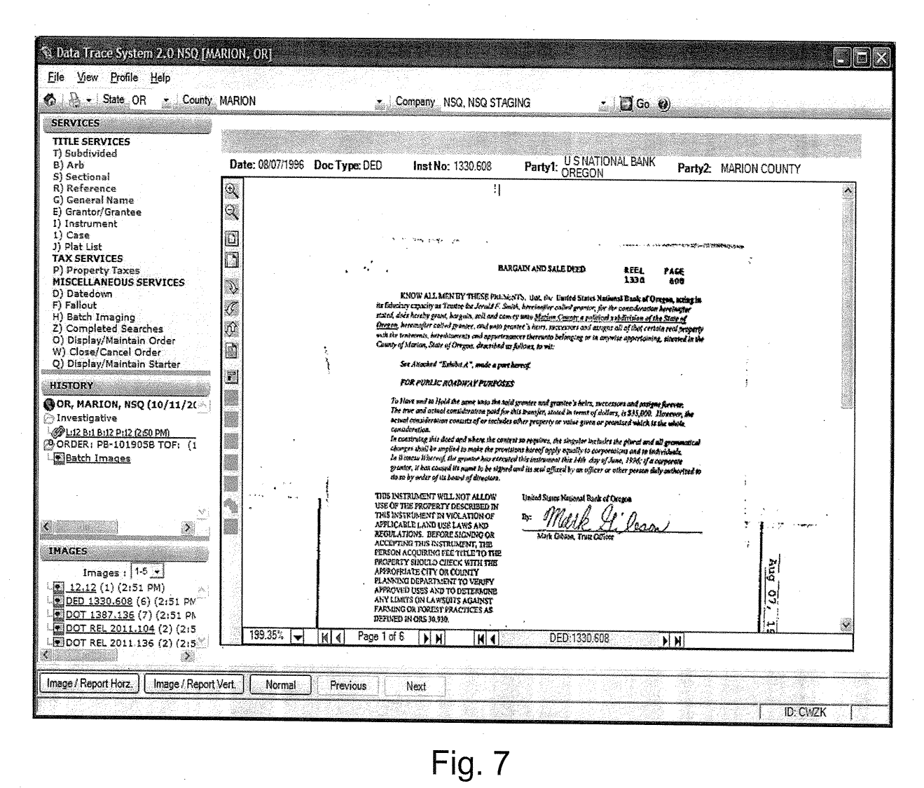

FIG. 7 is a GUI illustrating an image viewer layout according to an embodiment of the invention.

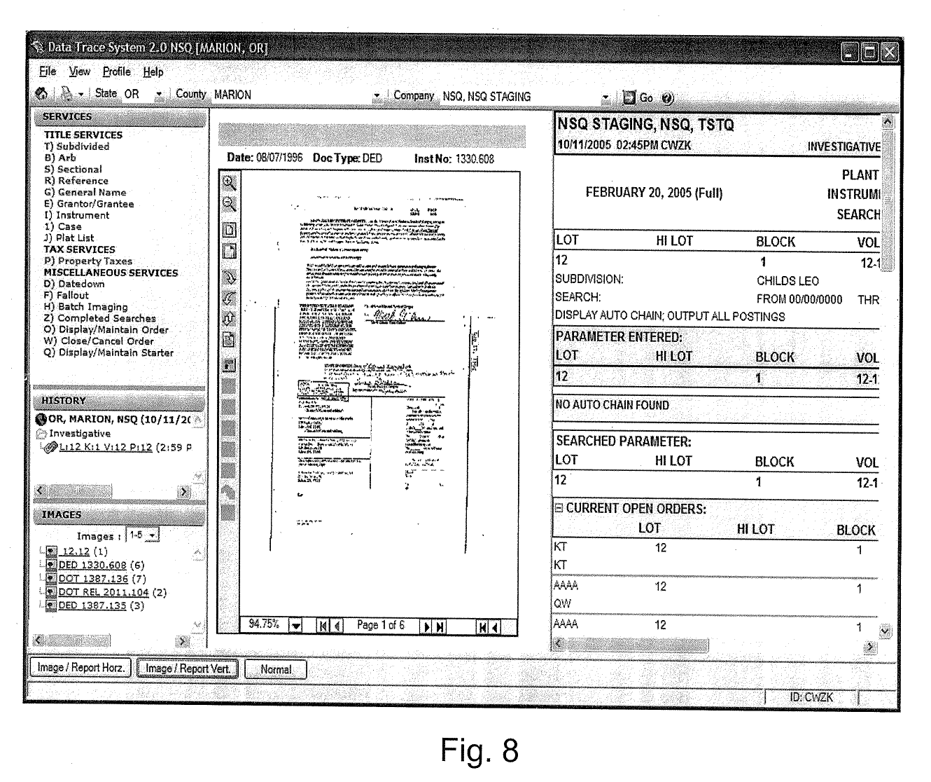

FIG. 8 is a GUI illustrating a split screen report and an image viewer layout according to an embodiment of the invention.

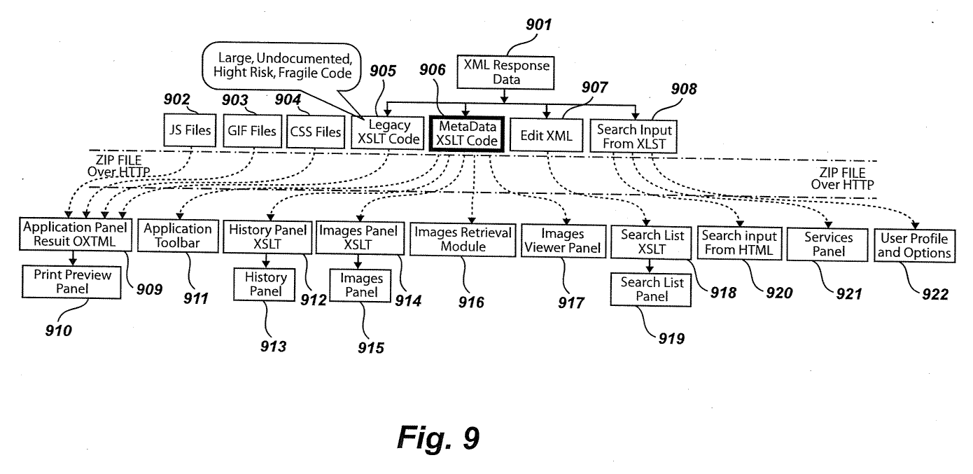

FIG. 9 is a block diagram of an XML fan-out transformation into ZIP over HTTP and HTML panel data flows according to an embodiment of the invention. The XML response data 901 (423 in FIG. 4) is transformed into a number of files 905, 906, 907 and 908, combined with a number of static files 902, 903 and 904 and packaged and transmitted to the client PC using ZIP over HTTP. The legacy XSLT code 905 (417 in FIG. 4) contains many lines of source code implementing detailed business logic for transforming the XML response data 901. The search result HTML report 909 relies on JS files 902, GIF files 903 and CSS files 904 to introduce interactivity.

Metadata XSLT code 906 is fanned out into a history panel 913 via a history panel XSLT 912 and an images panel 915 via an images panel XSLT 914. The image retrieval module 916 uses the metadata XSLT code 906 to determine the image key and the document type. The image viewer panel 917 is used to select pages and view, rotate pan, flip and zoom the image. For data validation warnings and errors, the XML response data 901 is fed into a search list XSLT 918 and then into a search list panel 919. The search input form XSLT 908 generates a search input form HTML 920 with the appropriate edit box names, sizes and locations, a services panel 921 and a user profile and options screens 922. Each transaction type can update all panels.

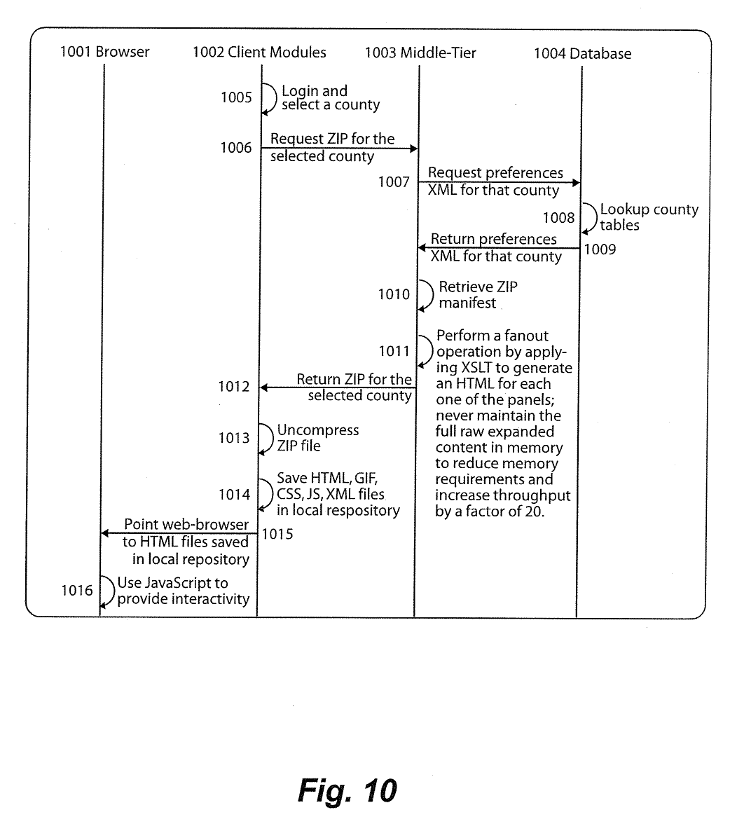

FIG. 10 is a flow diagram showing events of a transaction type for downloading and caching a county specific website according to an embodiment of the invention. After entering a login and selecting a county (1005), a XML request is transmitted from the client modules 401 to the middle-tier layers of the selected county (1006). The XML request is transmitted to the database 422 (1007). The database 422 performs a lookup and retrieve of the county specific preferences (1008) and the data is transmitted to the middle tier layer (1009). The file specifying the content of the ZIP fan-out is parsed (1010) and a loop is performed to apply a number of XSLTs, each of which produces an HTML to be added to the ZIP (1011). In addition to those dynamic files, numerous static GIF, CSS and JS files may be added. The ZIP file for the selected county is transmitted to the client modules 401 (1012). The client modules 401 uncompress the ZIP file (1013) and save the retrieved HTML, GIF, CSS, JS and XML files in the memory 405 (1014). The web-browser component may invoke and point to the newly cashed HTML files of which links are all pointing to local files (1015). The user may use JavaScript to provide interactivity with the web browser performing the application's functions.

In the title insurance industry, each county has its own custom input forms and data formats. This has caused significant challenges when expanding the system coverage to new counties. The county selection transaction is designed so that all the input forms can be customized for each and every county. The database 422 stores tables that specify which input fields and formats are to be used for each and every county. As a result, expanding the coverage to a new county entails making database table update, and if necessary, programming a new data format.

FIG. 11 is a GUI that allows placing orders using a search list shopping cart concept where all operations are performed without server interactivity (i.e., offline) according to an embodiment of the invention. A request is sent after an order request is submitted via a Submit button 1114. The user selects a link representing specific services from a title services panel 1101. The link points to an HTML page in the memory 405. The HTML page has an order panel with fields 1102 for entering order information, and a search parameter panel with fields 1103 for specifying the property and party information for the subject transaction. The specific field names, lengths and location are controlled by the XML 423 retrieved from the database 422 and generated by the XSLT modules 417. When entering search parameters, a search parameter selector 1104 allows selecting the type of search item that are to be added to the search list shopping cart. The content of the search list shopping cart can be modified using the Add button 1105 to add new items, the Update button 1106 to update the content of the selected item, the Clear button 1107 to clear the content of the selected item and the Delete button 1108 to completely delete the selected item. The layout of the search list shopping cart is generated using an XSLT applied by JavaScript on the search list content XML, which is also manipulated by JavaScript. For each item in the search list shopping cart, the search list shopping cart layout contains order information 1109, qualifiers 1110, entered search parameters 1111, product description 1112 and options 1113.

The buttons and controls are implemented in JavaScript and HTML (a.k.a. DHTML) and the Submit button 1114 is implemented using the client modules 401. The mouse click and key stroke events captured by the web-browser components pass to the client modules 401. Similarly, the button and menu selection events captured by the client modules 401 pass to the web-browser and update the panels.

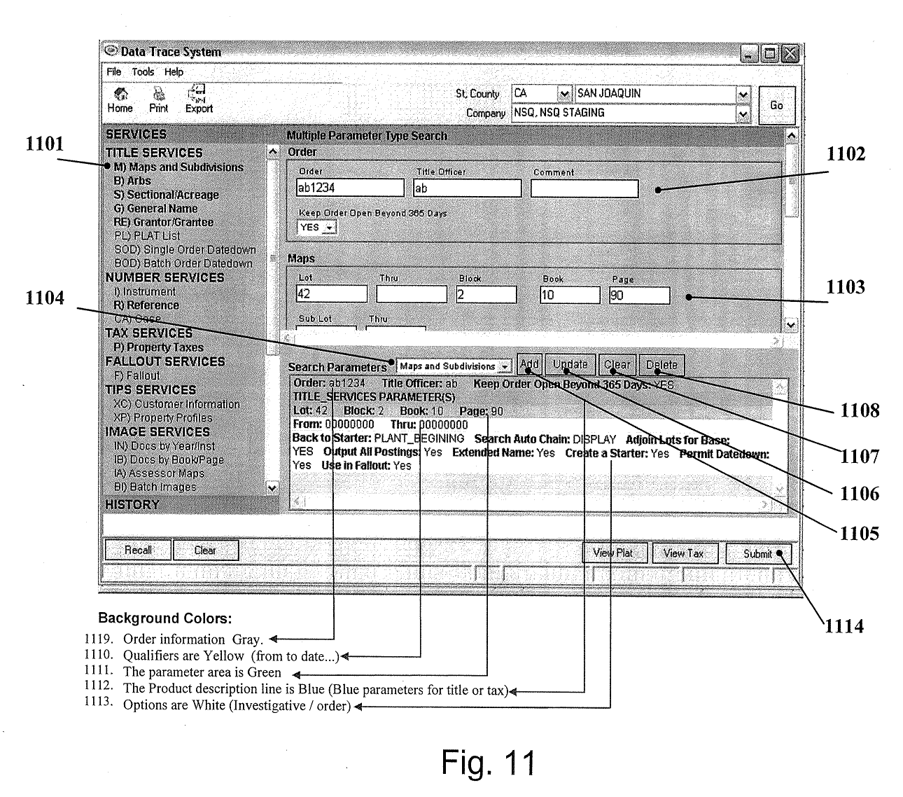

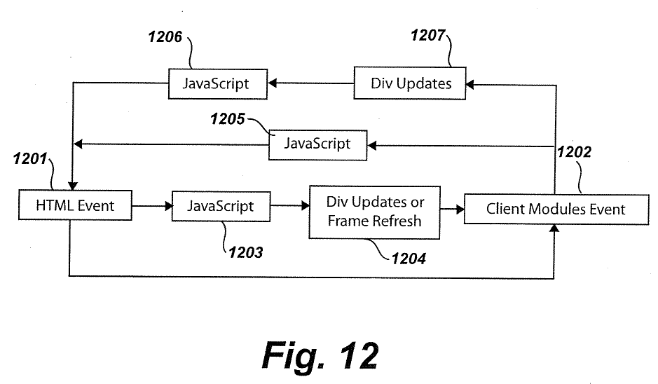

FIG. 12 is a flow diagram showing several possible paths that can occur for event propagation and information exchange between the browser and the client modules according to an embodiment of the invention. An HTML event 1201 can be converted into a client module event 1202 using document object model (DOM) event propagation API. When DOM event propagation API is not appropriate, the HTML event 1201 can be passed to the client through an intermediary JavaScript function 1203, which updates a div element or refreshes a frame 1204, an operation which, in turn, triggers the client module event 1202. Passing events from the client module events to trigger an HTML event can be done through a direct JavaScript call 1205, which can be preceded by a div update 1207 with XML data to be consumed by the operation.

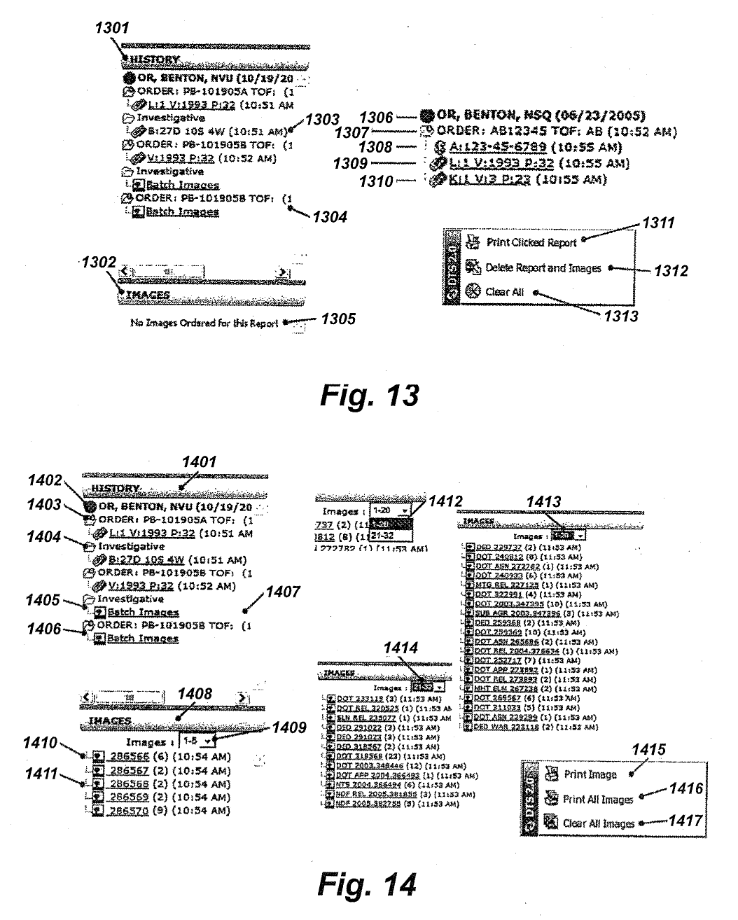

FIG. 13 are screen shots of history panels according to an embodiment of the invention. The screen shots include a history panel title bar 1301 and an images panel title bar 1302. The user can obtain report searches 1303 and image searches 1304. Mouse clicks can be used to select items in the history panel. Every change county transaction is recorded as a separate item 1306 in the history panel. An entry in the history panel conducted searches includes abbreviated order information 1307, a short description of tax parcel information 1308, and a short description of title legal description information 1309 and 1310. Multiple tax and title entries are possible. All history panel items have associated tool-tips providing their full length description. Right-clicking an item in the history panel presents a context menu having the options to print the reports 1311 (with its images) for the order that corresponds to the selected item, delete the report 1312 for the order that corresponds to the selected item and clear all entries 1313 in the history panel.

FIG. 14 are screen shots of history and image panels according to an embodiment of the invention. The history panel includes a title bar 1401, a change county item 1402 for each change county transaction and a folder 1403-1406 for every search performed. Both investigative and order searches are supported and each can request search reports or document images. An investigative search report item 1404 and an investigative document image request 1405 are designated using an icon. An order search report item 1403 and an order document image request 1406 are designated using an icon and provide a short description of the order. A long full-length description can also be provided. The currently selected item may be designated by a distinctive background color 1407. Selection of a link item in the history panel populates the image panel with the document images requested for that item. In situations where no images are requested, the No Images Ordered for this Report message 1305 is displayed.

The images panel includes a title bar 1408, an image range selector 1409 and an item 1410 for each image requested. The currently selected item may be designated by a distinctive background color 1411. Selecting the drop-down list reveals the total number of images requests, organized in ranges 1412. According to the example in FIG. 14, a total of 32 images were ordered for the selected report. Selecting the range of 1-20 populates links to the first 20 images requested 1413. Selecting the range of 21-32 populates links to the last 12 images requested 1414. Right-clicking an item in the images panel displays a context menu having the options to print the selected image 1415, print all images 1416 requested for the selected images panel item, and clear all images 1417 in the images panel.

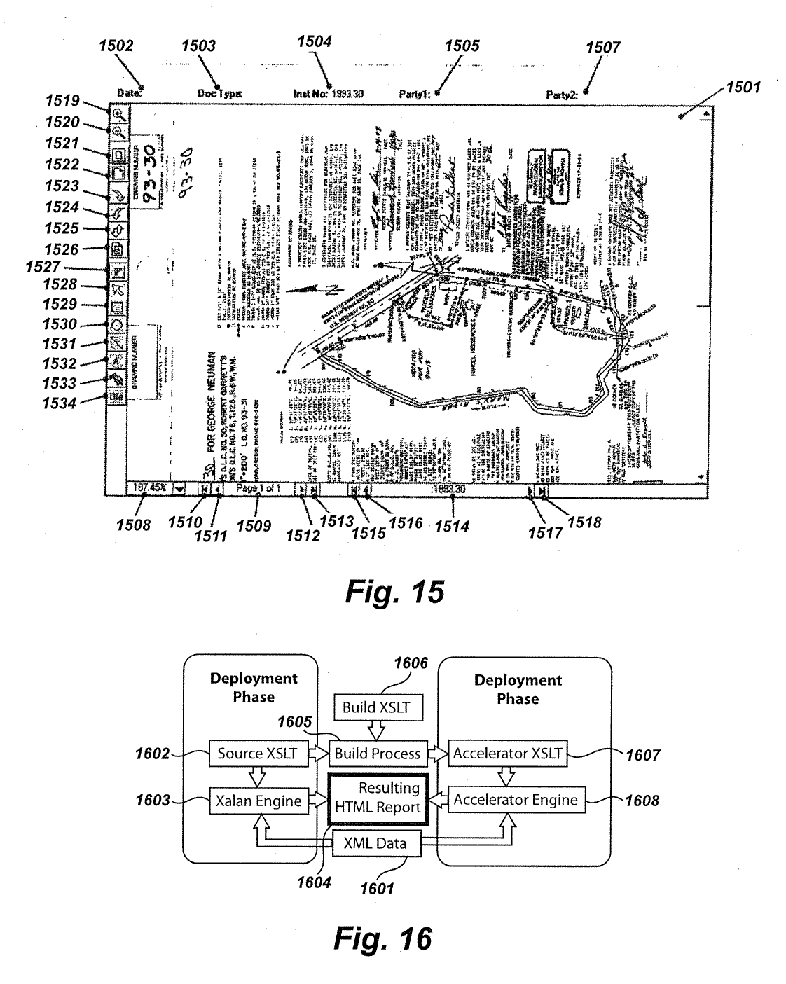

FIG. 15 is a screen shot of a document image viewer layout according to an embodiment of the invention. The image is positioned in a viewing window 1501. The top portion of the viewer specifies the date 1502 the document was recorded, the document type 1503, the instrument number 1504, the first party information 1505 and the second party information 1507. The bottom portion of the viewer provides zoom control 1508. The bottom portion of the viewer also provides a navigation toolbar having a page control specifying the current page 1509, allowing browsing to the previous page 1511, the next page 1512, the first page 1510 of the document and the last page 1513 of the document. In addition, the navigation toolbar allows browsing documents within the order. The navigation toolbar includes a document selector control specifying the current document identifier 1514, the previous document requested 1516, the next document requested 1517, the first document requested 1515, and the last document requested 1518 for the order.

The left portion of the viewing window 1501 includes a viewing toolbar that provides functions such as zoom in 1519, zoom out 1520, fit in windows 1521, fit width 1522, rotate clockwise 1523, rotate counter-clockwise 1524, flip vertically 1525 and print current image 1526. The left portion of the viewing window 1501 also includes an annotation toolbar for annotating the document image and printing the image with the annotations. Selecting the annotation mode button 1527 enters the annotation mode. Annotations can be selected using the selection button 1528. Various types of annotations can be added, including rectangle 1529, oval 1530, arrow 1531 and text 1532. An electronic highlighter is also provided 1533. In addition, a disclaimer can be added to be shows on the print using the disclaimer button 1534.

FIG. 16 is a flow diagram showing the automated optimization of XSLT report generation according to an embodiment of the invention. The XML data 1601 retrieved from the database 422 is combined with the report generator XSLT 417 using a standard transformation engine 1604, such as Xalan. To unlock the value of XSLT accelerators, a build process 1605 applies a build XSLT 1606 to a source report generation XSLT 1602 and produces a new version of the code referred to as Accelerator XSLT 1607. When the Accelerator XSLT 1607 is deployed, the Accelerator Engine 1608 applies the Accelerator XSLT 1607 onto the same XML data 1601 used at development time. The ability to retrieve and browse large reports is improved if one is capable of streaming data as it is being collected, and at the same time, preventing the HTML from becoming too large to the point that the client application freezes.

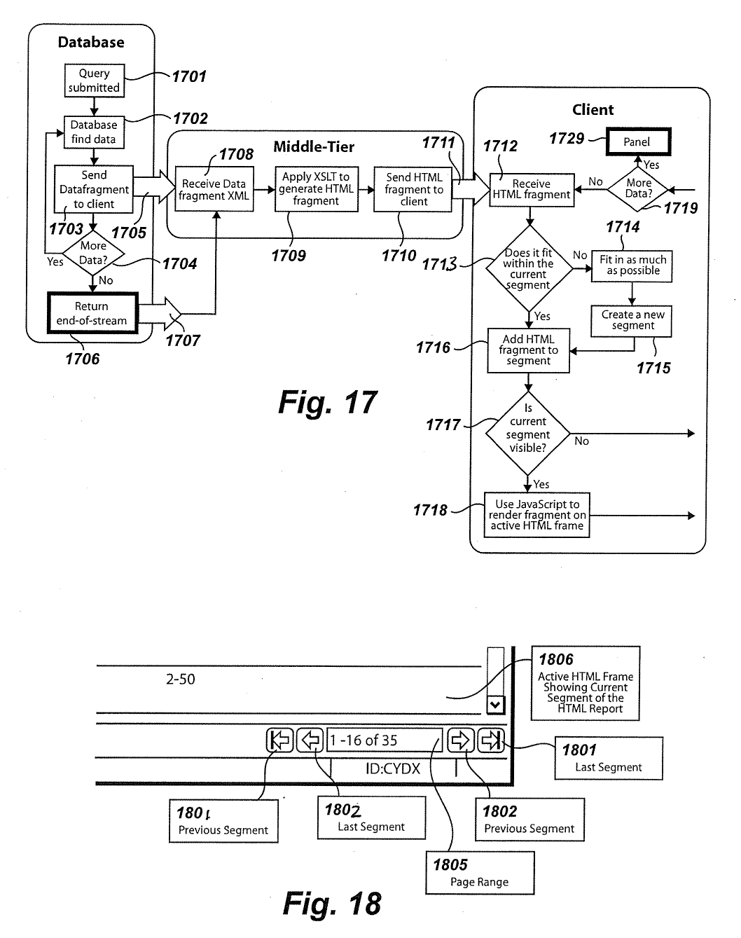

FIG. 17 is a flow diagram illustrating a method of integrating streaming and segmentation according to an embodiment of the invention. The database features are as follows. When a query is submitted (1701), the database searches for data (1702). As matches are found, the data fragments are sent to the middle-tier layer (1708) using the XML interface (1705). The database continues to search for additional data. If the data fragment found was the last fragment (1706), the appropriate message (1707) is returned back to the middle-tier layer (1708).

The middle-tier layer features are as follows. As an XML data fragment is received (1708), the XSLT transformation 417 is applied to produce the corresponding HTML report fragment (1709), which is sent back to the client (1710) through the XML interface (1711).

The client features are as follows. As an HTML fragment is received (1712), the client modules 401 determine whether it can fit in the existing segment (1713). If it can fit, then it simply adds it to the current segment (1716). If it cannot fit, then it adds as much as possible into the existing segment (1714), and creates a new segment (1715) into which the reminder of the fragment is placed (1716). Once the current segment is up to date, the client modules 401 determine whether the current segment is visible on the screen (1717). If it is, then the client modules 401 use JavaScript to update the visible HTML with the newly added HTML fragment (1718). In both cases, unless this was the last fragment (1719), the client goes back to wait for the next fragment. If this is the last fragment, the download is complete (1720).

FIG. 18 is a portion of a GUI illustrating segmentation GUI control according to an embodiment of the invention. The GUI interface of streaming simply appends a short initial HTML with additional fragments as they arrive. The HTML report, which constitutes the search result, is rendered (1806). A segmentation control is used with the buttons of first segment 1801, last segment 1803, previous segment 1802, and next segment 1804. A page range test box 1805 is used to indicate which pages the current segment contains.

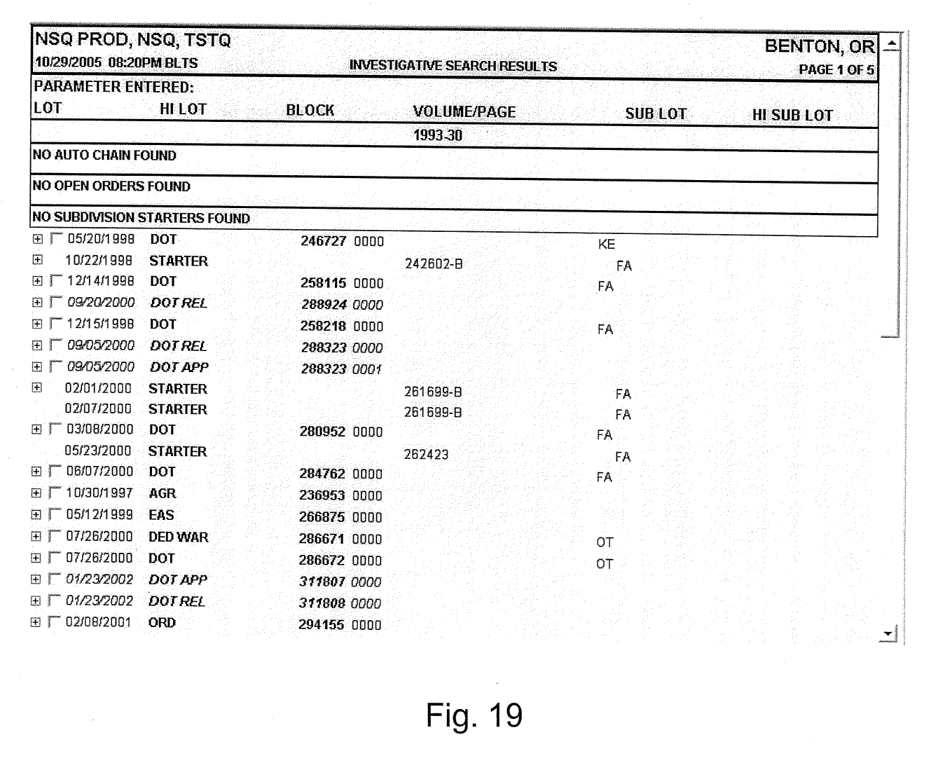

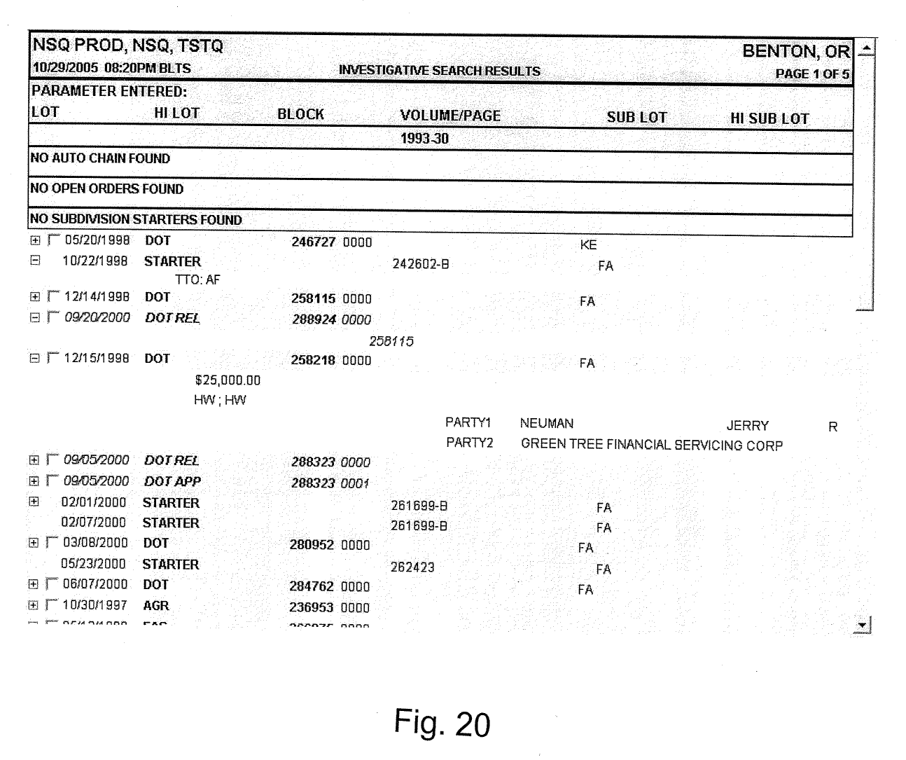

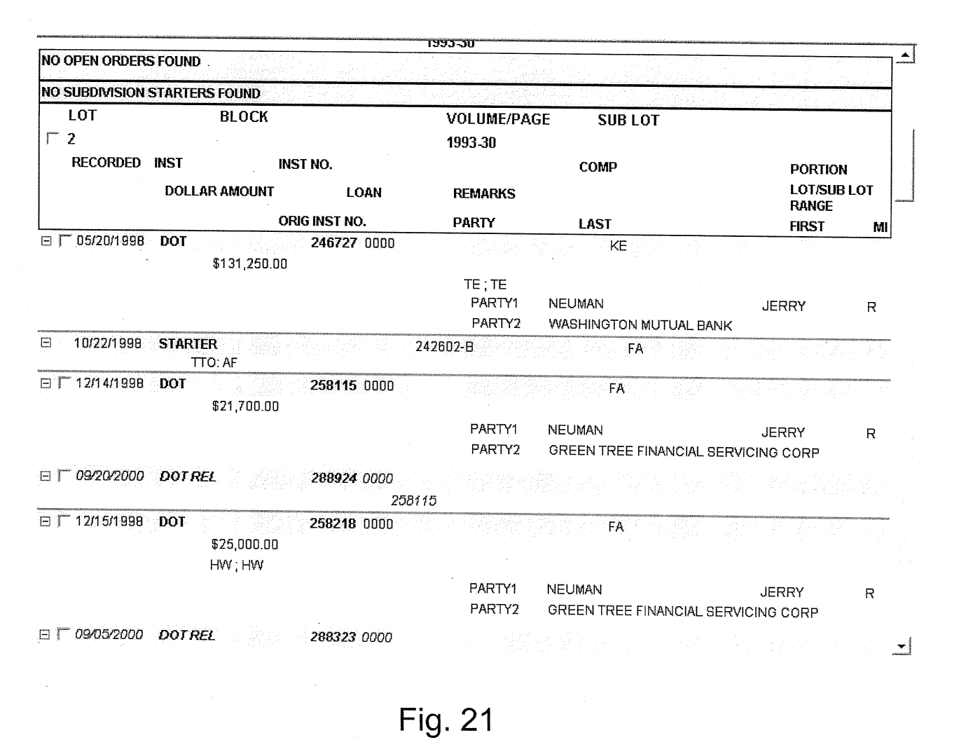

To improve review productivity, the present invention allows viewing the result HTML report in various modes as depicted in FIGS. 19, 20 and 21. FIG. 19 illustrates a summary view of the results, whereas the first line of each posting is shown together with the checkbox used to indicate that the image document for this posting should be retrieved. FIG. 20 illustrates a partially expanded view in which the user selectively expands individual postings of interest. FIG. 21 illustrates a fully expanded view in which all the fields for all postings are shown. In addition to various interactive viewing modes, the present invention provides report annotation capabilities. Postings can be highlighted and stricken. Those annotations can be shows on printed reports.

Those skilled in the art will appreciate that the various illustrative logical blocks, modules, circuits, and algorithms described in connection with the embodiments disclosed herein may be implemented as electronic hardware, computer software, or combinations of both. To illustrate this interchangeability of hardware and software, various illustrative components, blocks, modules, circuits, and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or preformed with a general purpose processing device, a digital signal processing device (DSP), an application specific integrated circuit (ASIC), a field programmable gate array (FPGA) or other programmable logic device, discrete gate or transistor logic, discrete hardware components, or any combination thereof designed to perform the functions described herein. A general purpose processing device may be a microprocessing device, but in the alternative, the processing device may be any conventional processing device, processing device, microprocessing device, or state machine. A processing device may also be implemented as a combination of computing devices, e.g., a combination of a DSP and a microprocessing device, a plurality of microprocessing devices, one or more microprocessing devices in conjunction with a DSP core or any other such configuration.

The apparatus, methods or algorithms described in connection with the embodiments disclosed herein may be embodied directly in hardware, software, or combination thereof. In software the methods or algorithms may be embodied in one or more instructions that may be executed by a processing device. The instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the processing device such the processing device can read information from, and write information to, the storage medium. In the alternative, the storage medium may be integral to the processing device. The processing device and the storage medium may reside in an ASIC. The ASIC may reside in a user terminal. In the alternative, the processing device and the storage medium may reside as discrete components in a user terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The invention may be embodied in other specific forms without departing from its spirit or essential characteristics. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A method of searching for and retrieving documents comprising:
receiving a county selection;
transmitting a request for a ZIP file comprising a plurality of graphical user interfaces for the selected county;
receiving the ZIP file specifying a fan-out operation;
performing the fan-out operation to generate a ZIP stream; and
invoking a browser component API to point to a plurality of HTML pages.

2. The method of claim 1 further comprising writing the ZIP stream to an output stream.

3. The method of claim 2 further comprising placing the content of the output stream in an HTTP response.

4. The method of claim 3 further comprising receiving the ZIP stream contained in the HTTP response.

5. The method of claim 1 further comprising:
extracting a plurality of components from the ZIP stream; and
storing the plurality of components in memory.

6. The method of claim 1 further comprising accepting user interface events that invoke JavaScript handlers.

7. The method of claim 6 further comprising executing JavaScript function that trigger browser events to be passed to client modules across the browser component API.

8. The method of claim 1 further comprising interpreting user interface events and browser events.

9. The method of claim 1 further comprising initiating a transaction based on the interpreted user interface events and browser events.

10. A method of obtaining county documents comprising:
receiving a county name;
transmitting an XML request over an HTTP to a database containing documents of the county name;
receiving an XML response to the XML request;
converting the XML response into a plurality of HTML files; and
generating a ZIP file using the plurality of HTML files.

11. The method of claim 10 further comprising generating a ZIP data stream using the XML response.

12. The method of claim 11 further comprising converting the ZIP data stream to the ZIP file.

13. The method of claim 10 wherein converting the XML response into a plurality of HTML files comprises using a plurality of XSLT modules.

14. The method of claim 10 wherein the XML response comprises a status of the documents.

15. The method of claim 10 wherein the XML response comprises information to assemble a URL pointing to the documents.

16. A document searching and retrieval system comprising:
a plurality of client applications;
a plurality of middle-tier servers;
a plurality of document databases storing searchable document indexes;
a plurality of image databases storing searchable scanned document image indexes;
a first network connection between the plurality of client applications and the plurality of middle-tier servers; and
a second network connection between the plurality of middle-tier servers and the plurality of document databases and the plurality of image databases.

17. The system of claim 16 wherein the plurality of document databases comprises:
a plurality of property tax databases storing searchable document indexes; and
a plurality of title plant databases storing searchable document indexes.

18. The system of claim 16 further comprising a plurality of XSLT report generation modules configured to produce modified XSLT code which executes on an XSLT accelerator engine to produce resulting HTML reports.

19. The system of claim 18 wherein the resulting HTML reports are substantially identical to reports produced by source XSLT code running on a standard XSLT engine.

20. A client-server system comprising:
a client application capable of transmitting an HTTP request to a server;
a middle-tier server responding to the HTTP request with a ZIP file over HTTP; and
a network connecting the client application to the middle-tier server.
